(19) United States
(12) Patent Application Publication
(10) Pub. No.: US 2006/0228688 A1
(43) Pub. Date: Oct. 12, 2006

(54) Electronic education system

(75) Inventors: Wan-Keung Wong, Hong Kong (CN); Nelson Cue, Hong Kong (CN)

Correspondence Address: BUCHANAN, INGERSOLL & ROONEY PC, POST OFFICE BOX 1404, ALEXANDRIA, VA, 22313-1404, US

(73) Assignee: Top Rise Co. Ltd., Hong Kong SAR (CN)

(21) Appl. No.: 11/100,482

(22) Filed: Apr. 7, 2005

(51) Int. Cl. G09B 3/00

(52) U.S. Cl. 434/350

(57) ABSTRACT

Electronic education systems generally includes a central computer, a display unit, and various student terminals connected to the central computer by a data transmission network. The network transmits data to and from the central computer for analysis, the data includes students' task and their response. Such a system is relatively expensive, and is not portable. This invention provides an electronic education system for evaluating responses from a group of students to a set of multiple choice questions. Each of the questions having a maximum of x choices. The system includes at least one IR transmission device for transmitting a plurality of IR signals to a console, which includes a processor for analyzing the responses, a memory for storing the multiple choice questions and corresponding answers, output means for outputting data to a display device, and receiving means for receiving the IR signals.

### FIELD OF THE INVENTION

This invention relates to electronic education systems, particularly those for evaluating multiple choice questions for a group of students.

### BACKGROUND OF THE INVENTION

Electronic education systems are known. A typical system may be described in U.S. Pat. No. 5,002,491, which includes a central computer, a display unit, and various student terminals connected to the central computer by a data transmission network. The network transmits data to and from the central computer for analysis, the data includes students' task and their response. Such a system is relatively expensive, and is not portable.

### OBJECTS OF THE INVENTION

Therefore, it is an object of this invention to provide a portable electronic education system with relatively low manufacturing costs, or resolve at least one or more of the problems as set forth in the prior art. As a minimum, it is an object of this invention to provide the public with a useful choice.

### SUMMARY OF THE INVENTION

Accordingly, this invention provides an electronic education system for evaluating responses from a group of students to a set of multiple choice questions. Each of the questions having a maximum of x choices. The system includes:
at least one IR transmission device for transmitting a plurality of IR signals to a console, each of said IR signals corresponds with one of the x choices, and each IR transmission device has an unique identity encoded in the IR signals;
a console including:
   a processor for analyzing the responses;
   a memory for storing the multiple choice questions and corresponding answers;
   output means for outputting data to a display device; and
   receiving means for receiving the IR signals.

Preferably, the output means is audio and visual output. More preferably, the display device includes a television set. The display device is preferred to include a LCD screen and a television set.

Optionally, the memory is a memory card removable from the electronic education system.

### BRIEF DESCRIPTION OF THE DRAWINGS

Preferred embodiments of the present invention will now be explained by way of example and with reference to the accompanying drawings in which:

FIG. 1 shows the general structure of the system of this invention; and

FIG. 2 shows a schematic scheme of the working flow chart of the system of this invention.

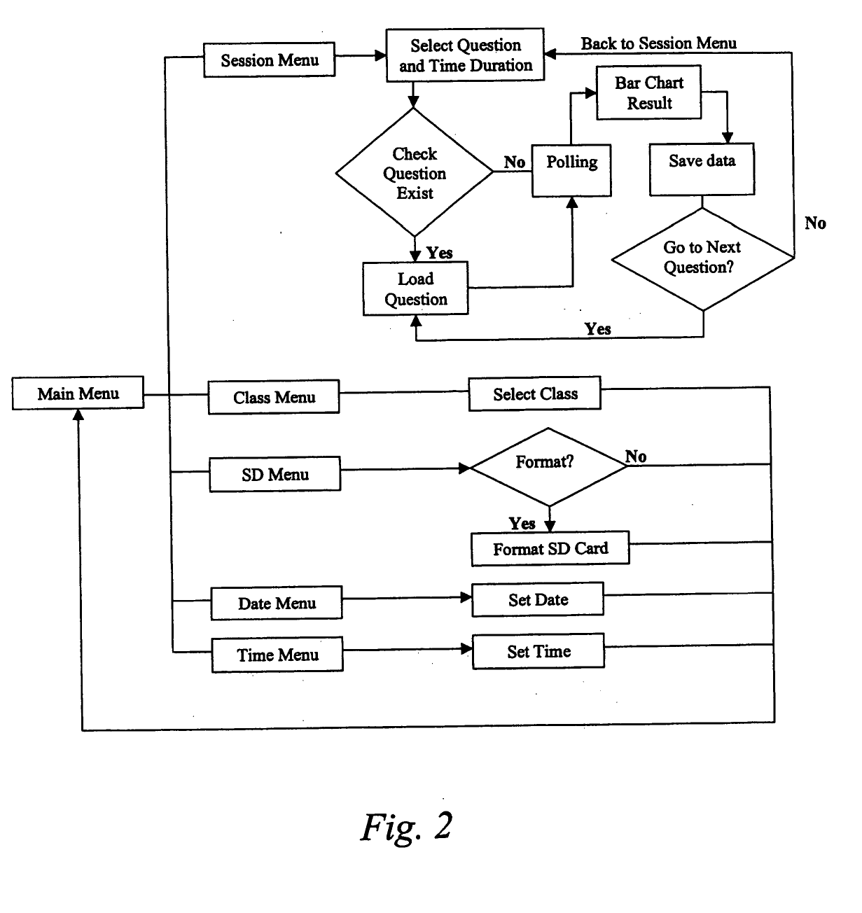

### DETAILED DESCRIPTION OF THE PREFERRED EMBODIMENT

This invention is now described by way of example with reference to the figures in the following paragraphs. List 1 is a part list so that the reference numerals in the figures may be easily referred to.

The electronic education system of this invention may be used for evaluating answers of multiple choice questions. Each question has a maximum of x choices, for example, four or five choices. More and less choices are of course possible. To one extreme, there can be only two choices of true-and-false type questions.

At least one IR transmission device is provided. Preferably, each student is provided with one IR transmission device. The IR transmission device transmits a plurality of IR signals to the main console. Each of the IR signals corresponds with one of the x choices, which may be distinguished by, for example, the frequencies of the IR signals. Preferably, each IR transmission device has an unique identity encoded in the IR signals, so that it is possible to trace back the source of the responses.

A console is provided to perform the storage and analyzing functions of the system. The console may include a processor, a memory, and input/output devices. The processor is responsible for analyzing the responses. Typically, a 16-bit microcontroller unit may be sufficient for this purpose, although more powerful processor may be used. A memory is provided to store the multiple choice questions and corresponding answers. Various forms of the memory are possible. The memory may be integrated with the processor on one chip, or in the form of a memory card (like secure-digital card, or compact flash card). A memory card slot is required if memory card is used. Of course, it is possible to read from or write to the memory cards.

The console also has a receiver for receiving the IR signals, and outputting device for outputting data to a display device, like a television set. The construction and working of the receiver and outputting device are generally known and will not be further described.

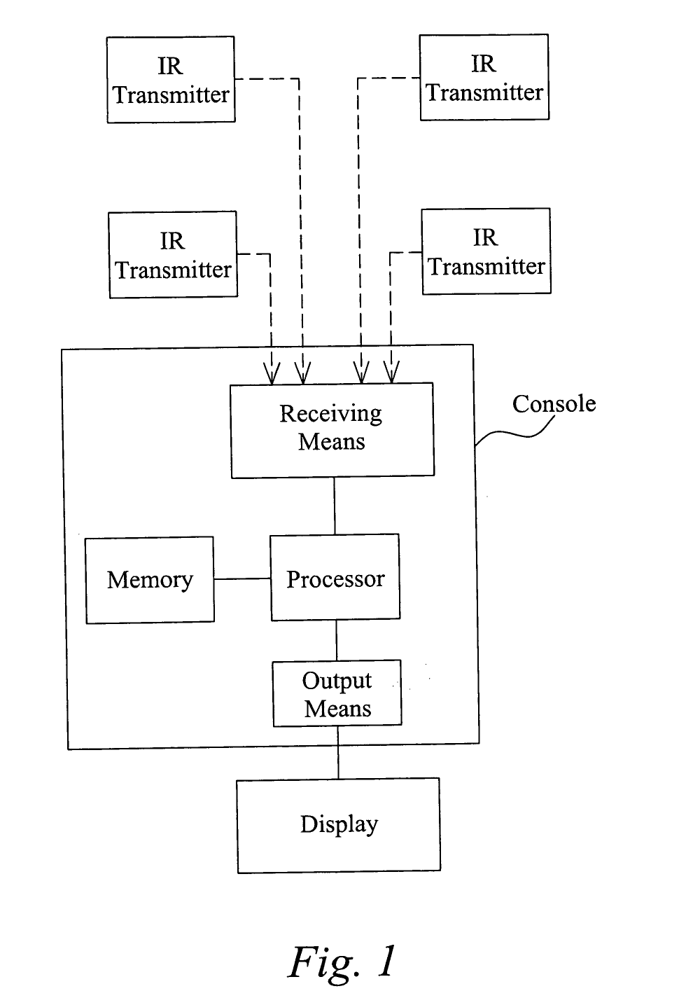

An example of the working flow chart is shown in FIG. 1. When the console is turned on, a main menu is presented to the teacher with several choices. When the teacher chooses the “Session menu”, he will be required to choose the question to be displayed, and the time allowed for the students to answer the questions. Responses from the IR transmission devices will then be collected before the answering time ends. The processor then compares each of the responses with the answer of the question. Correct and wrong responses will of course be counted as “correct” and “wrong”, respectively, while responses in incorrect format (for example, responses other than true or false are chosen) may be counted as “wrong”. A bar chart result may then be presented. The resulted may be saved in the memory for further analysis.

One skilled in the art will realize there are many design choices in the above example. For example, responses in incorrect format may be counted as “missing” instead of “wrong”. The menu can of course be designed in many different ways according to the choice of the designer. Various display means may be used, including television, laptop computer, e-book reader, and so on.

Objects, features, and aspects of the present invention are disclosed in or are obvious from the following description. It is to be understood by one of ordinary skill in the art that the present discussion is a description of exemplary embodiments only, and is not intended as limiting the broader aspects of the present invention, which broader aspects are embodied in the exemplary constructions.

While the preferred embodiment of the present invention has been described in detail by the examples, it is apparent that modifications and adaptations of the present invention will occur to those skilled in the art. Furthermore, the embodiments of the present invention shall not be interpreted to be restricted by the examples or figures only. It is to be expressly understood, however, that such modifications and adaptations are within the scope of the present invention, as set forth in the following claims. For instance, features illustrated or described as part of one embodiment can be used on another embodiment to yield a still further embodiment. Thus, it is intended that the present invention cover such modifications and variations as come within the scope of the claims and their equivalents.

1. An electronic education system for evaluating responses from a group of students to a set of multiple choice questions, each of the questions having a maximum of x choices, the system including:
at least one IR transmission device for transmitting a plurality of IR signals to a console, each of said IR signals corresponds with one of the x choices, and each IR transmission device has an unique identity encoded in the IR signals;
a console including:
a processor for analyzing the responses;
a memory for storing the multiple choice questions and corresponding answers;
output means for outputting data to a display device; and
receiving means for receiving the IR signals.

2. The electronic education system of claim 1, wherein the output means is audio and visual output.

3. The electronic education system of claim 2, wherein the display device includes a television set.

4. The electronic education system of claim 3, wherein the display device includes a LCD screen and a television set.

5. The electronic education system of claim 1, wherein the memory is a memory card removable from the electronic education system.

6. The electronic education system of claim 1, wherein the memory is rewritable.
